(19) United States
(12) Patent Application Publication
(10) Pub. No.: US 2016/0043906 A1
(43) Pub. Date: Feb. 11, 2016

(54) SYSTEM AND METHOD FOR PROCESSING CLOUD PLATFORM CHARACTERISTICS

(71) Applicant: Telstra Corporation Limited, Melbourne (AU)

(72) Inventor: Mohammad Firoj Mithani, Travancore (AU)

(21) Appl. No.: 14/656,110

(22) Filed: Mar. 12, 2015

(30) Foreign Application Priority Data
Aug. 8, 2014 (AU) 2014903082

(51) Int. Cl. H04L 12/24; G06F 3/0484; G06F 17/30; G06F 3/0482

(52) U.S. Cl. CPC H04L 41/22; H04L 41/12; G06F 3/0482; G06F 3/04842; G06F 17/30867

(57) ABSTRACT

A cloud platform selection system including:
a questionnaire module configured to:
   select input requests from a plurality of predetermined input requests relating to a plurality of preselected cloud computing platforms,
   send data to a user-interface (UI) module representing each input request and a plurality of choices for selection in response to each input request,
   receive user input data representing selection of one of the plurality of choices for each input request, and
   determine a subset of platforms from the preselected cloud computing platforms using the user input data and predefined associations between the choices and the preselected cloud computing platforms; and
an analytical hierarchy process module configured to:
   receive user input data representing a ranking of characteristics of the preselected cloud computing platforms,
   access predefined ratings of the characteristics for the determined subset of platforms, and
   determine a suitable platform of the subset using the ranking and the predefined ratings in an analytical hierarchy process.

### BACKGROUND

Cloud computing environments (which may be referred to as “host environments” or “platforms”) provide virtualisation of remote physical computing devices so that computer-processing capacity, and computer-readable storage, can be accessed by a user's local computing devices connected to the remote devices, without the user devices requiring to be specifically configured for the underlying physical remote computing devices and configurations. Available cloud platforms may include private platforms, e.g., Telstra's Enterprise Platform and Integrated Cloud (EPIC), Virtual Server Farm (VSF) and “CSX Cloud”, and public platforms, e.g., Amazon Web Services (AWS).

Users or organisations may wish to connect their local systems to an appropriate cloud platform; however, as existing cloud platforms have become increasingly varied and technically complicated, it may be very difficult, e.g., particularly for an unsophisticated (non-technical/business users) computer user, to efficiently and/or correctly select a platform with appropriate technical characteristics for the user's computing requirements.

Accordingly, there may be a need for improved tools to provide a better assessment of the appropriateness of different cloud platforms based on technical requirements of the user and characteristics of the cloud platforms.

It is desired to address or ameliorate one or more disadvantages or limitations associated with the prior art, or to at least provide a useful alternative.

### SUMMARY

In accordance with the present invention, there is provided a cloud platform selection system including:

a questionnaire module configured to:
select input requests from a plurality of predetermined input requests relating to a plurality of preselected cloud computing platforms,
send data to a user-interface (UI) module representing each input request and a plurality of choices for selection in response to each input request,
receive user input data representing selection of one of the plurality of choices for each input request, and
determine a subset of platforms from the preselected cloud computing platforms using the user input data and predefined associations between the choices and the preselected cloud computing platforms; and

an analytical hierarchy process module configured to:
receive user input data representing a ranking of characteristics of the preselected cloud computing platforms,
access predefined ratings of the characteristics for the determined subset of platforms, and
determine a suitable platform of the subset using the ranking and the predefined ratings in an analytical hierarchy process.

The present invention also provides a cloud platform selection method including the steps of:

selecting input requests from a plurality of predetermined input requests relating to a plurality of preselected cloud computing platforms;

sending data to a user-interface (UI) module representing each input request and a plurality of choices for selection in response to each input request;

receiving user input data representing selection of one of the plurality of choices for each input request;

determining a subset of platforms from the preselected cloud computing platforms using the user input data and predefined associations between the choices and the preselected cloud computing platforms;

receiving user input data representing a ranking of characteristics of the preselected cloud computing platforms;

accessing predefined ratings of the characteristics for the determined subset of platforms; and

determining a suitable platform of the subset using the ranking and the predefined ratings in an analytical hierarchy process.

The present invention also provides one or more non-transitory computer-readable storage media including machine-readable code that causes one or more computer processors to execute the method.

The system may include a reporting module for generating a report based on the characteristics of the determined suitable platform.

The UI module may be configured to:

receive user input to generate the user input data, and

generate data to display the determined suitable platform.

The questionnaire module may be configured to select at least one input request based on user input received in response to a previous one of the selected input requests.

The predetermined input requests may include multiple-choice questions, single-choice questions, and value requests.

Each choice may be represented by a choice identifier (ID), which may be a quasi-unique data value in an electronic database. Each predetermined platform may be represented by a platform identifier (ID), which may be a quasi-unique data value in an electronic database. The predefined associations between the choices and the preselected cloud computing platforms may be represented as mappings between the choice IDs and the platform IDs, which may be relationships (or mappings or associations) in a relational database.

The predetermined input requests may be in at least one electronic database. The input requests may be represented by input data, which may include electronic input states.

Selecting the subset of platforms using the questionnaire module may be referred to as “filtering” or “eliminating” ones of the initial predefined set of preselected platforms.

The questionnaire module may be configured to generate the input requests until the predefined user input requests that are associated with remaining platforms in the subset (that is, the “non-eliminated” platforms) have received input.

The questionnaire module may generate the user input requests until a preselected (one or more) number of the platforms remains in the subset, or until only one platform is identified.

The user input representing the ranking may include ranking data indicative of relative importance values of the characteristics.

### BRIEF DESCRIPTION OF THE DRAWINGS

Preferred embodiments of the present invention are hereinafter further described, by way of non-limiting example only, with reference to the accompanying drawings, in which:

FIG. 1 is a schematic diagram of a hardware configuration of a system for processing cloud computing platform requirements;

FIG. 2 is a schematic diagram of software components (also referred to as “modules”) in the system:

FIGS. 3A and 3B are, in combination, a data-model diagram of a database structure in the system;

FIG. 4 is a flowchart of a method for processing characteristics of cloud computing platforms performed by the system;

FIGS. 5A and 5B are flowcharts of a questionnaire process in the method;

FIG. 6 is a flowchart of an analytic hierarchy process in the method;

FIG. 7 is a flowchart of a costing process in the method; and

FIG. 8 is a flowchart of a report generation process in the method.

### DETAILED DESCRIPTION

### Overview

The described system and method can identify a most suitable cloud computing platform based on a user's selected requirements and predetermined platform characteristics. The cloud computing platform may be referred to as a “hosting environment”. The system and method presents a series of user-input requests in the form of detailed questions. The questions are selected dynamically, e.g., according to a selected sequence. The sequence may be selected based on whether the user requests business-user inputs or technical-user inputs. The questions are selectively presented (not in any predefined sequence) to gather just sufficient data to analyse the workload from technology, business and other constraints (cost, security, and uptime). The selected user choices (or answers) provide an initial subset or shortlist of available platforms. The selected user choices are used to eliminate unsuitable platforms from the subset.

The most suitable of the subset of platforms is then selected using an analytic hierarchy process (AHP) analysis. The AHP analysis uses a ranking of desirable characteristics from the user inputs. These ranked characteristics may also be referred to as “constraints”, “factors”, “common characteristics”, “continuous characteristics”. “ranking characteristics”, or “preferred characteristics”. These characteristics may include computing uptime, cost, and/or security.

Once the system and method has determined the most suitable platform, the system and method produces a detailed report with appropriate recommendations that enable users to adopt the most suitable platform. The report may include business benefits, and risks/limitations, of the most suitable platform as well as associated capital expenditure (CapEx) and (OpEx) costs.

The system and method use a qualitative analysis of the user requirements and the platform characteristics. The elimination of unsuitable platforms prior to AHP analysis, e.g., down to 2 or 3 or 4 platforms, allows the AHP to be performed more rapidly.

### System 100

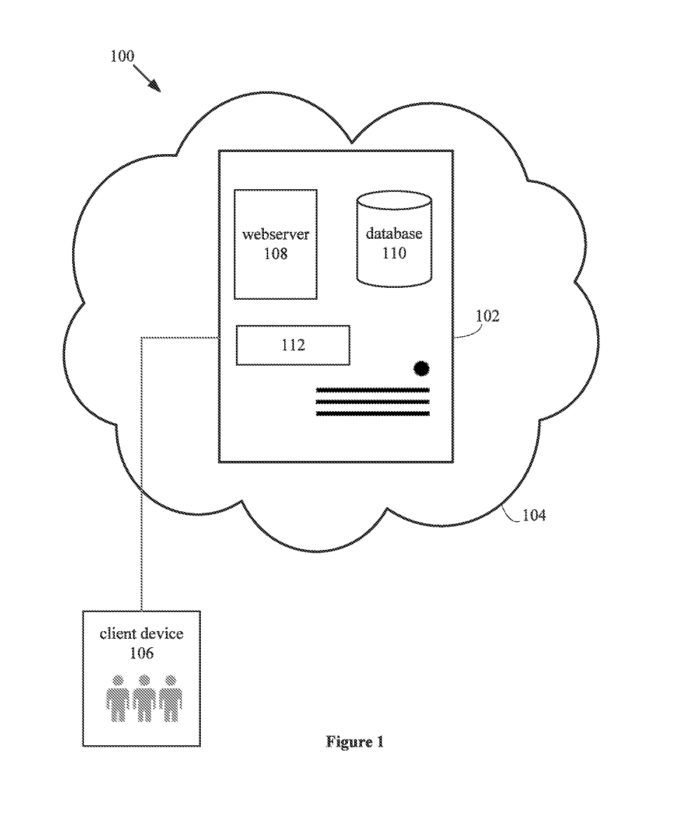

As shown in FIG. 1, a system 100 for processing characteristics of cloud computing platforms includes a computer server 102 (e.g., Windows Server 2008) hosted in a cloud computing platform 104 (e.g., Microsoft Azure), and in electronic communication (e.g., over the Internet) with at least one client computing device 106. The server 102 includes an application server 108, which may operate as, or include, a web server (e.g., Microsoft's Internet Information Services), a database 110 (e.g., Microsoft SQL Server), and an authentication module 112 for authenticating users of the client devices 106 when accessing server 102, which may form a 3-tier architecture. In embodiments, the server 102 can be a plurality of servers, and the platform 104 can be a private cloud platform (e.g., from Telstra Corporation).

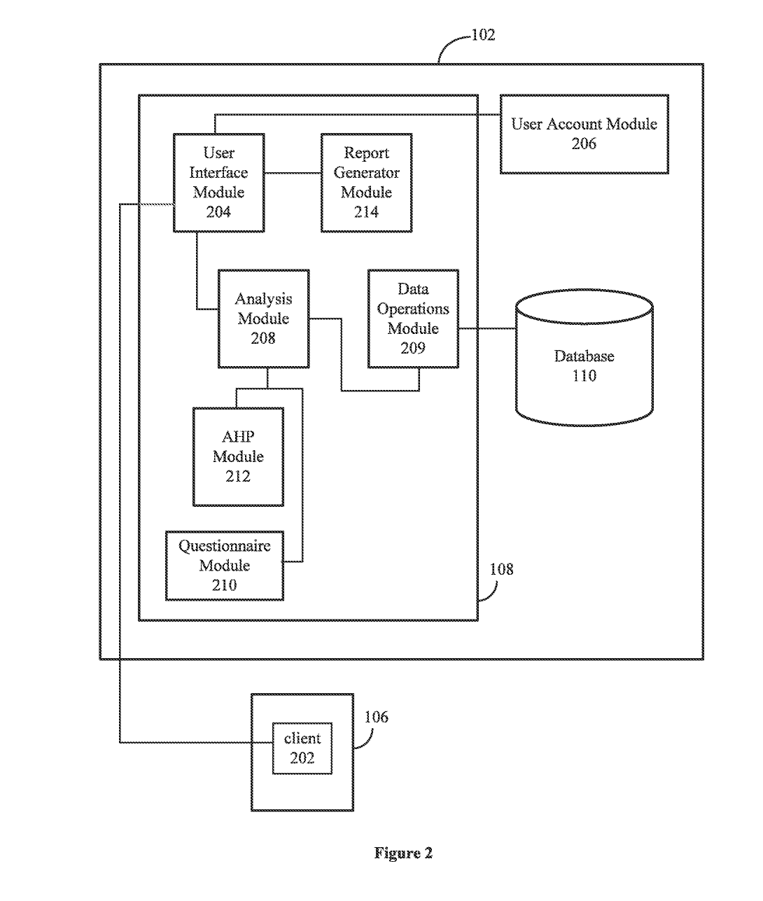

As shown in FIG. 2, the client device 106 includes a client 202 in communication with a user interface (UI) module 204 of the application server 108. The UI module 204 is in communication with a user account module 206 (e.g., Windows server user account store) that provides authentication processes based on the UT module 204 for user details entered through the client 202. The UI module 204 is connected to an analysis module 208 of the application server 108 that performs analysis of user inputs received by the UI module 204, and generates input requests for the user that are sent to the user by the UT module 204. The analysis module 208 is in communication with a data operations module 209 that sends information to, and retrieves information from, the database 110. The data operations module 209 is in the application 108, and communicates electronically with the database 110 (e.g., based on SQL queries).

The analysis module 208 is in communication with a questionnaire module 210, and an AHP module 212, both of which are in the application server 108. The questionnaire module 210 selects the input requests for the analysis module 208 by performing a questionnaire process 500 described hereinafter. The AHP module 212 performs an analytic hierarchy process 600 described hereinafter. The UI module 204 is connected to a report generator module 214 that executes a reporting process 800 described hereinafter.

The server 102 may include a standard electronic computer system, such as a commercially available server computer system based on a 32-bit or 64-bit Intel architecture.

The processes and/or methods executed or performed by the server 102 may be implemented in the form of programming instructions of the one or more components or modules 204, 206, 208, 209, 210, 212, 214 stored on non-volatile (e.g., hard disk) computer-readable electrical storage associated with the computer system. The modules 204, 206, 208, 209, 210, 212, 214 may be built using a computer programming tools, including Microsoft ASP.NET, Language-Integrated Query (LINQ), and C Sharp (C#) in a .Net framework. In embodiments, at least portions of the modules 204, 206, 208, 209, 210, 212, 214 could be implemented as one or more dedicated electronic hardware components, e.g., application-specific integrated circuits (ASICs) and/or field programmable gate arrays (FPGAs). In operation, the modules 204, 206, 208, 209, 210, 212, 214 communicate using electronic communication protocols.

The server 102 includes at least one or more of the following computer components, interconnected by an electronic communications bus: random access memory (RAM), at least one computer processor (e.g., a microprocessor), and external computer interfaces, which may include: universal serial bus (USB) interfaces (at least one of which may be connected to one or more user-interface devices, such as a keyboard, and a pointing device, e.g., a mouse or touchpad), a network interface connector (NIC) that connects the server 102 to a data communications network such as the Internet, and a display adapter, which is connected to a display device such as a liquid-crystal display (LCD) panel device. The server 102 includes a plurality of standard components or modules, including: an operating system (OS), scripting language modules, and structured query language (SQL) modules which allow data to be stored in and retrieved/accessed from the database 110.

The boundaries between the modules 204, 206, 208, 209, 210, 212, 214 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations. Alternatively, such actions may be embodied in the structure of circuitry that implements such functionality, such as the micro-code of a complex instruction set computer (CISC) or a reduced instruction set computer (RISC), firmware programmed into programmable or erasable/programmable devices, the configuration of a field-programmable gate array (FPGA), the design of a gate array or full-custom application-specific integrated circuit (ASIC), or the like. Each of the blocks of the flow diagrams, described hereinafter, may be executed by one of the modules 204, 206, 208, 209, 210, 212, 214 or a portion hereof. The processes may be embodied in a machine-readable and/or computer-readable medium for configuring a computer system to execute the method. The software modules may be stored within and/or transmitted to a computer system memory to configure the computer system to perform the functions of the module. The server 102 normally processes information according to a program (a list of internally stored instructions such as a particular application program and/or an operating system) and produces resultant output information via input/output (I/O) devices. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process. The described data generation, data storage and data communications operations include digital data operations. The digital data may include electronic data defined by logic circuits-which may include binary logic circuits-represented by electronic quantities, which may include voltage, current and/or resistance. The data may include electronic states in at least one electronic processing machine.

### Database 110

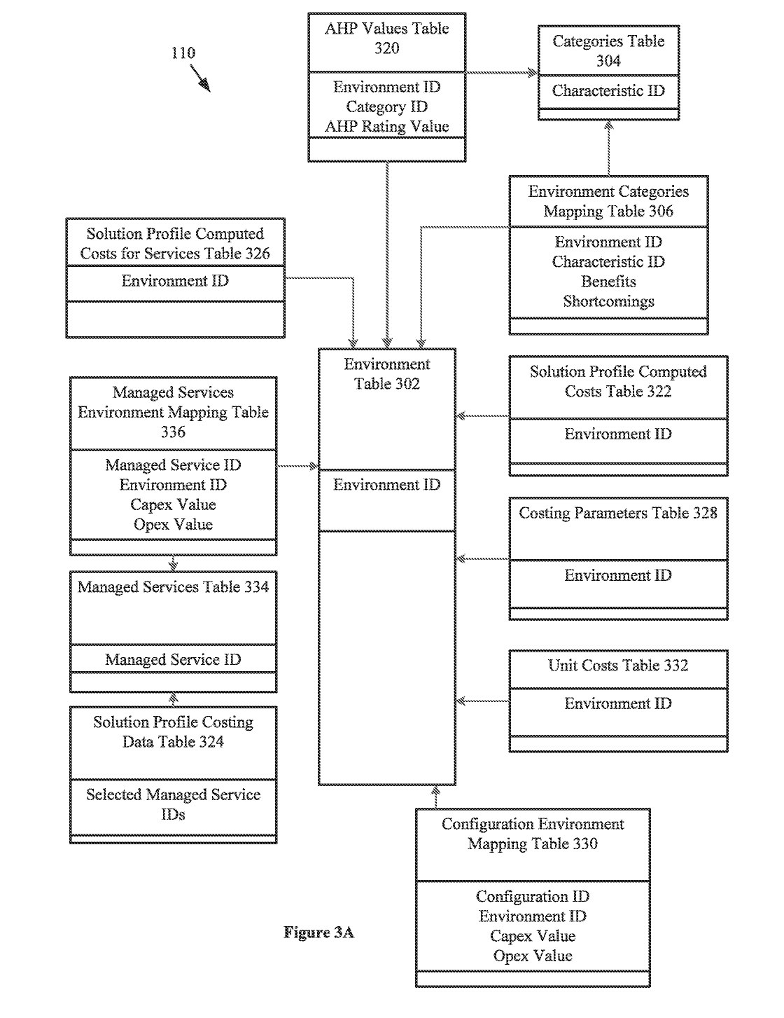

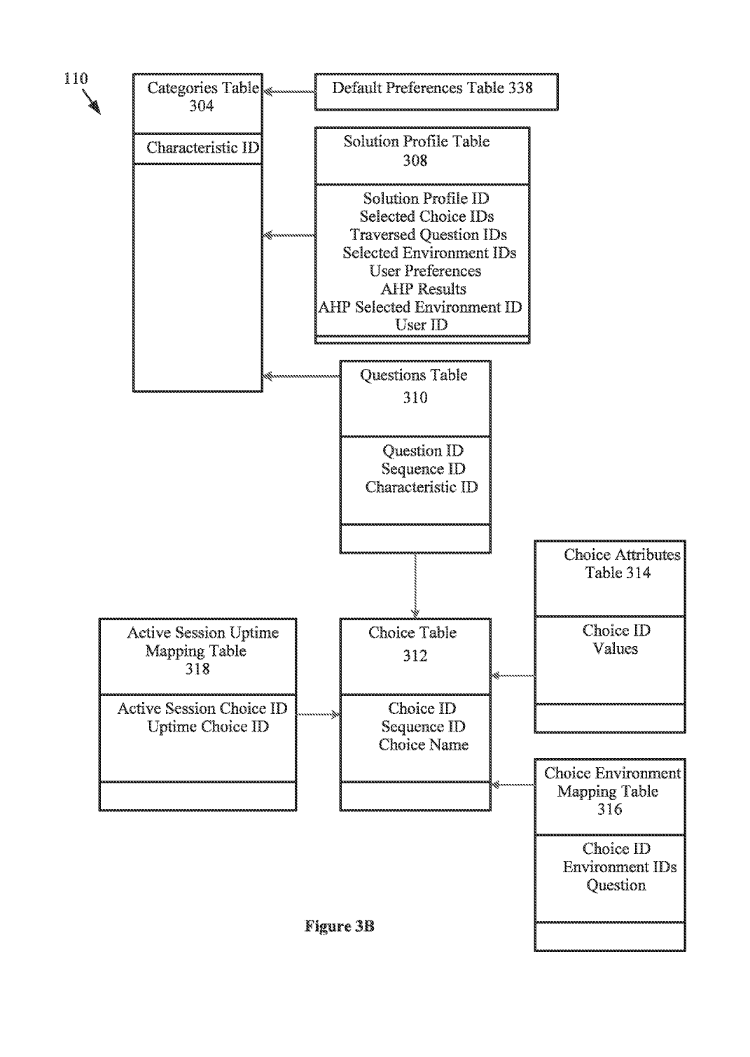

As shown in FIGS. 3A and 3B, the database 110 includes stored electronic data representing a plurality of data tables, each with one or more data fields configured to store respective data values.

The database 110 includes an environment table 302 with a list of the available platforms (or “environments”) that are available for analysis by the system 100. The environment table 302 includes an environment identifier (ID), and a cloud type for each available platform. The list of available platforms is predetermined or preselected by an administrator of the system 100.

The database 110 includes a categories table 304 that lists the different characteristics of the available environments. These characteristics may be referred to herein as “categories”. The characteristics are identified by a characteristic ID (also referred to as a “category ID”) in the categories table 304.

The database 110 includes an environment categories mapping table 306 that includes characteristic IDs in association with environment IDs, and data representing benefits and limitations of the available platforms associated with each of the characteristics (which may be a security, cost, and/or uptime). This table 306 maps the characteristic IDs to one or more of the environment IDs as predetermined by a system administrator.

The database 110 includes a solution profile table 308 that includes a solution profile ID, and details, received from the client 202, associated with a session or an instance of operation of the system 100. The solution profile table 308 may contain information identifying the user of the client 202, including a user ID, which may be used for authentication by the user account module 206. The solution profile table 308 may also include a name for the profile (which may also be referred to as a “session”). The solution profile table 308 includes, for each profile ID, a list of the traversed question IDs, thus identifying the questions that have been traversed by the questionnaire module 210, and potentially answered by the client 202. The solution profile table 208 includes a list of selected choice IDs that identify the answers given to the questions by the client 202 (or answers generated automatically in the questionnaire process 500). The solution profile table 308 includes selected environment IDs representing the remaining environments that have been selected by the answering of the questions (i.e., the current subset of non-eliminated appropriate platforms). During operation of the questionnaire module 210, the values in the selected choice IDs, traversed question IDs and selected environments IDs change: at the commencement of the questionnaire process 500, the selected environment IDs may include all of the available environment IDs (from environment table 302), and these may be reduced as inappropriate environment IDs are eliminated by the answers received by the client 202. In a related manner, the traversed question IDs and selected choice IDs accumulate during operation of the questionnaire module 210, and the questionnaire process 500.

The database 110 includes a questions table 310 that includes a question ID field for each question (or predetermined input request) that can be presented by the questionnaire module 210. For each question ID, the questions table 310 includes one of the characteristic IDs, thus associating each question with one of the platform characteristics in the categories table 304. In the questions table 310, each question ID is also associated with a sequence ID, identifying a sequence of questioning. The sequence ID is used to set the questions in a sequence. Each swim lane has set of questions and all the questions are in a sequence dictated using sequence ID. For different users, e.g., different users (e.g., business users versus technical users) may require the questions to be phrased in different ways, or to request different information in different swim lanes. Thus the sequence ID is associated with different sequences of questions (based on question IDs) as preselected/predetermined by an administrator.

The database 110 includes a choice table 312 that includes a list of choice IDs representing the answers available for each question ID, represented as multiple-choice answers or as acceptable values (which may relate to a preselected numerical type and range). The answers may be shown by the user interface module 204 as alternative options/answers that can be selected as highlights. Dropdown lists or radio buttons may be used during the questionnaire to capture quantity of the resources, which be include vCPU, RAM, and VM, as well as additional selecting services, e.g., backup, monitoring, etc. In the choice table 312, each choice ID is associated with one of the question IDs, and one of the sequence IDs, thus defining which choices are available for which questions. In the choice table 310, each choice ID is associated with text and/or images for display by the user interface module 204 to the user via the client 202 to allow the user input to select one of the choice IDs for each question ID, thus answering each question in the sequence. The database 110 includes a choice attributes table 314 that includes, for each choice ID, parameters defining how the data for the choice can be accepted by the user interface module 204. The choice attributes defined in the choice attributes table 314 may include a minimum value, a maximum value, text values, and/or a data type.

Associated with the choice table 312 is a choice environment mapping table 316 that defines, for each choice ID, one or more environment IDs associated with, or related to, that choice ID. The choice environment mapping table 316 thus associates answers provided by the client 202 with ones of the available platforms, allowing the system to eliminate inappropriate ones of the available platforms determined from ones of the environment IDs that are not associated with selected choice IDs in the questionnaire process 500. Also associated with each choice ID are values relating to the required capacity of the workload associated with each choice, which may include a number of virtual machines, the number of virtual computer processing units (vCPUs), the number of random access memory (RAM) units, the storage required, the virtual machine type and/or a load balancer requirement. These requirements are identified in an active session uptime mapping table 318 with an active session choice ID and an uptime choice ID. These IDs are generated using combination of data and time when the session is established and profile is created. For example, “CS_{—}05062014_{—}012147398”, in which “CS” stands for Cloud Services, and rest of the digits denote time and data when profile was created by the user.

The database 110 includes an AHP values table 320 including, for each characteristic ID and each environment ID, a pre-determined AHP rating value. The AHP rating value is selected by the administrator of the system based on known performance characteristics of the available platforms, and converted into AHP values, which may require conversion to an integer value between one and nine.

The database 110 includes various costing tables with values that allow costing of the selected environment that is selected by the system 100. The database 110 includes a solution profile computed costs table 322 that contains, for each environment ID, data representing computed costs of vCPU, RAM, storage, etc, for cloud services, platforms and workloads. The database 110 includes a costing parameters table 328 that includes, for each environment ID, fields representing parameters used for generating costings of the different environments, e.g., whether backup is offered, maximum and minimum limitations on vCPU, RAM, storage, etc. The database 110 includes a configuration environment mappings table 330 that includes, for each environment ID, and for each configuration ID cost values for capital expenditure, and cost values for operational expenditure. The unit cost of each resource (vCPU, RAM, Storage etc.) is provided by the environment (platform owners/service providers), while the range (min/max) is provided by the services offered by the platforms. The database 110 includes a unit costs table 332 that includes, for each environment ID, predetermined or preselected values of unit costs for elements of the platform, which may include a cost per vCPU, a cost per RAM, a cost per unit of storage, a cost of backup, a firewall cost, a load balancer cost, an IP address cost, etc.

Database 110 includes a managed services table 334 and a managed services environment mapping table 336. The managed services table 334 includes a list of all managed services that are available, e.g., technical support, application support, monitoring and restore. The managed services environment mapping table 336 includes a mapping of available managed services represented by a managed service ID, for each environment ID, and includes relevant values for capital expenditure and operational expenditure and/or operational expenditure. The database 110 includes a solution profile costing data table 324 that includes computed costs of selected elements, e.g., vCPU, RAM, storage, etc for business services (workload/applications).

### Method 400

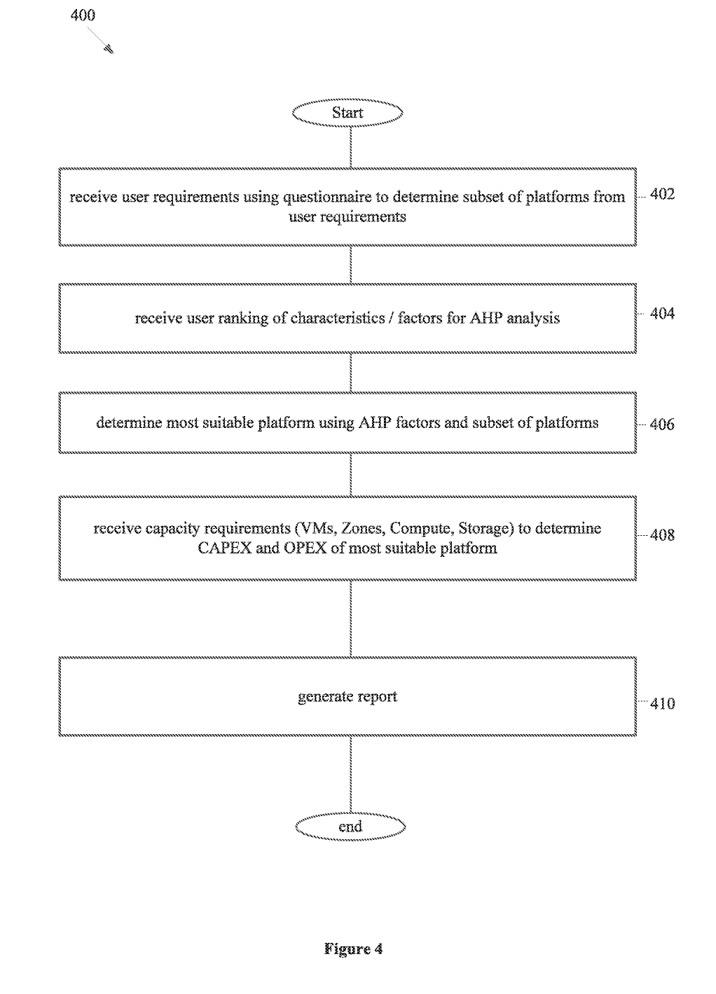

As shown in FIG. 4, a method 400 for processing characteristics of available cloud platforms, which may be performed by the system 100, includes at least the following steps:

receiving (which may be referred to as “capturing”) requirements of the user, based on data received from the client 202, and determining a subset of selected appropriate platforms from the user requirements using the questionnaire process 500 described hereinafter (step 402);

receiving (which may be referred to as “capturing”), from the client 202, a ranking of desirable characteristics (which may be referred to as “constraints” or “factors”) of the available platforms (e.g., security, cost and uptime), (step 404);

determining the most suitable platform (also referred to as the “best environment”) by means of the analytic hierarchy process (AHP) 600, using the desirable characteristics as processing constraints, as described hereinafter (step 406);

receiving (or capturing) the user inputs in relation to specific capacity requirements for the most suitable platform (which may include the number of virtual machines, the number of zones, the computer capacity, and/or the storage capacity), and determining a capital expenditure (CAPEX) and an operational expenditure (OPEX) in an appropriate currency of the selected most suitable platform from step 406 using a costing process 600 described hereinafter (step 408); and

generating a report using the report generation process 800 described hereinafter (step 410).

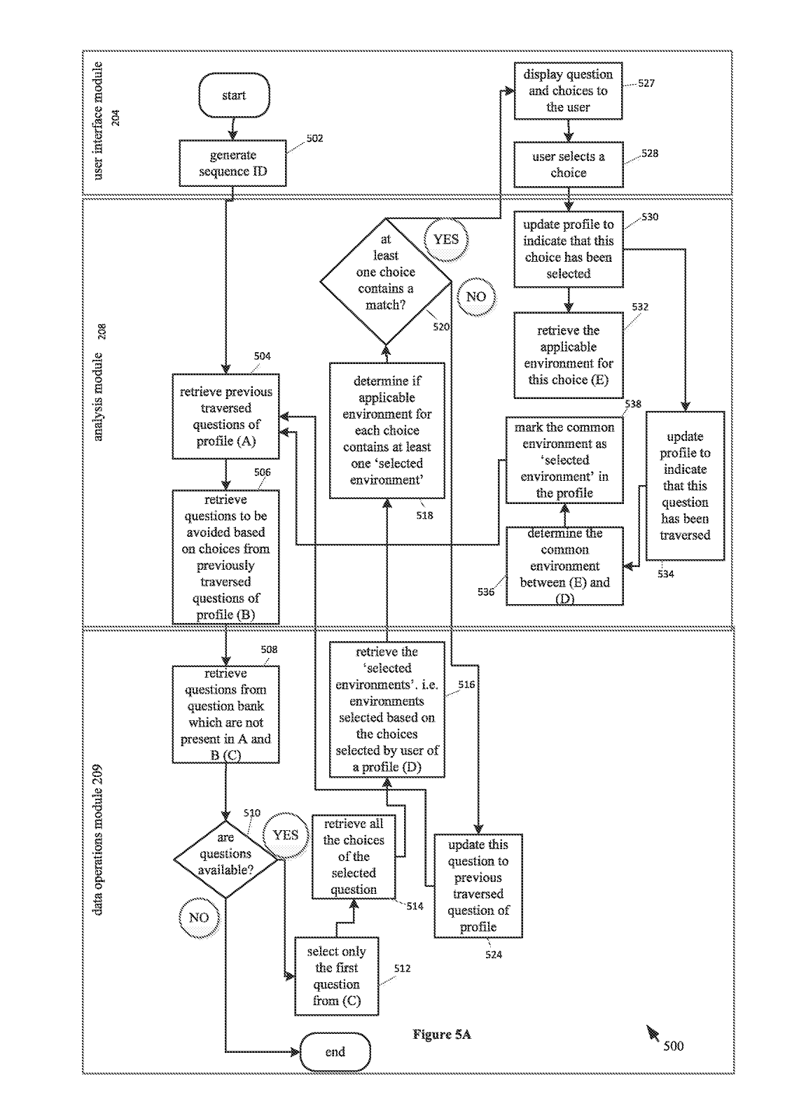

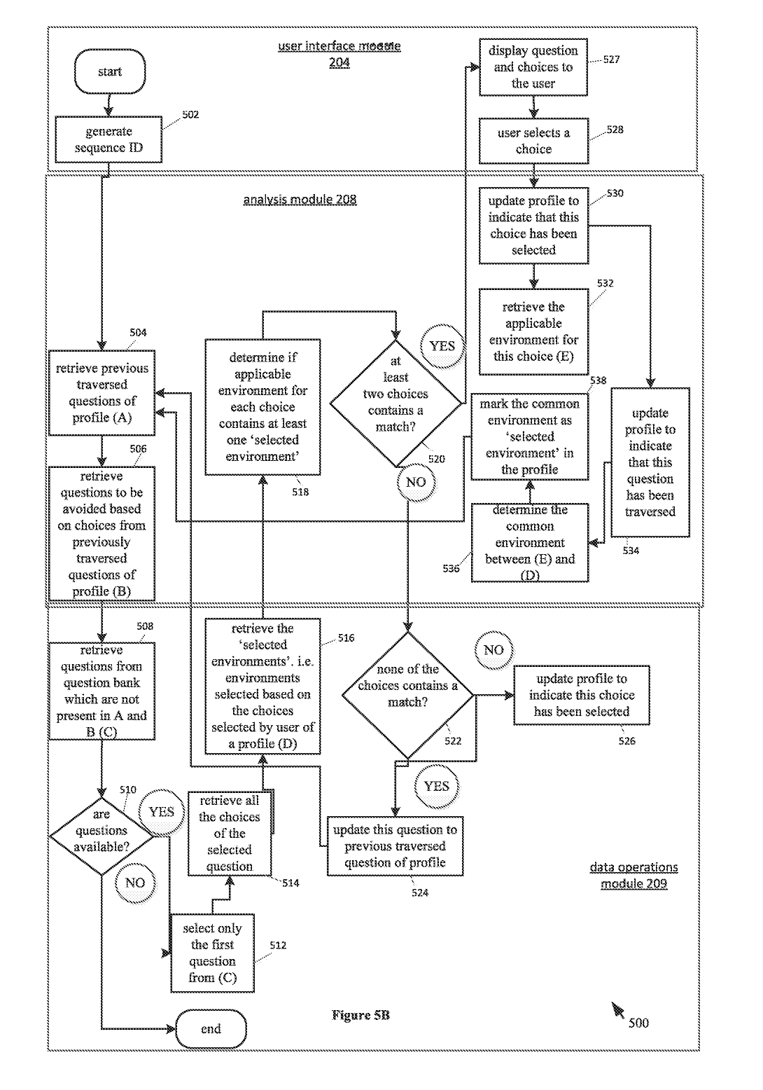

As shown in FIG. 5A, the questionnaire process 500 commences a new session with the user interface module 204 receiving a request from the client 202 to activate the questionnaire process 500, which includes the user interface module 204 selecting the relevant sequence ID for the questions based on the sequence selected by the client 202 (step 502). Upon receipt of the sequence ID from step 502, the analysis module 208 retrieves the traversed question IDs from the solution profile ID associated with the session (step 504). The set of previously traversed question IDs may be referred to as set “(A)”. The traversed question IDs are retrieved from the solution profile table 308 which may include a user ID value associated with the current user of the client 202 for the current session of the method 400. The analysis module 208 retrieves the selected choice IDs from the solution profile table 308, and thus the selected environment IDs that represent the current subset of the appropriate environments at this stage in the sequence. The current subset of environments may be referred to as set “(D)”. The analysis module 208 retrieves the question IDs that are associated with environment IDs, via the choice IDs, in tables 310, 312, 314, 316, that are no longer in the selected environment IDs in the solution profile table 308 (step 506). These are the eliminated question IDs referred to as set “(B)”. The analysis module 208 can then eliminate the questions that have already been answered, in step 504, and eliminate questions that are no longer relevant based on the choices from previously traversed questions in set (B) in step 506. Once the sets of questions (A) and (B) have been determined by the analysis module 208, the data operations module 209 retrieves questions from the database, as listed in questions table 310, that are not eliminated by (A) and (B) (step 508). The set of non-eliminated questions in step 508 may be referred to as set “(C)”. The data operations module 209 then determines whether the set (C) of question IDs is non-empty, i.e., whether any questions remain to be answered (step 510). If it is determined that no further questions remain to be answered in step 510, the questioning process 500 ends. If, on the other hand, it is determined in step 510 that further questions remain to be answered, the data operations module 209 one selects one of the question IDs from set (C) (step 512). The data operations module 209 then retrieves the choice IDs associated with the question selected in step 512 (step 514).

To determine which choices are relevant for the selected question in step 514, the data operations module 209 retrieves the selected environment IDs from the solution profile table 308 that are current for this stage in the sequence: these are the selected environments that remain relevant at this stage based on the previous choices of the user, and this set of currently selected environment IDs is set (D) (step 516). The analysis module 208 then determines which of the choice IDs associated with the questions selected in step 514 have associated environment IDs (in choice environment mapping table 316) that correspond to the selected environment IDs in set (D), thus determining which choices are applicable for this profile at this stage in the sequence (step 518). The analysis module 208 performs step 518 for each of the choice IDs associated with the selected question from step 514, then determines whether one or more of the selected choice IDs have associated environment IDs that correspond to the selected environment IDs (step 520). If the data operations module 209 determines in step 520 that none of the choice IDs matches, the data in the solution profile table 308 is updated to indicate that the question ID selected in 514 is now one of the traversed question IDs in solution profile table 308 (step 524). Following step 524, the analysis module 208 returns to step 504.

In an alternative embodiment of the questionnaire process 500, as shown in FIG. 5B, in step 520, the analysis module 208 determines whether two or more of the selected choice IDs have associated environment IDs that correspond to the selected environment IDs. If in step 520 it is determined that fewer than two of the choice IDs for the selected question ID have environment IDs associated with the selected environment IDs in set (D), the data operations module 209 determines if none of the choice IDs have a matching environment ID (step 522). If the data operations module 209 determines in step 522 that none of the choice IDs matches, the data in the solution profile table 308 is updated to indicate that the question ID selected in 514 is now one of the traversed question IDs in solution profile table 308 (step 524). If, on the other hand, in step 522 it is determined that one (and only one) of the choice IDs does match, this choice ID is automatically selected for the solution profile table 308, and added to the selected choice IDs (step 526), before the data operations module 202 adds the question ID to the traversed question IDs in step 524.

If it is determined in step 520 that one or more (or two or more) choice IDs match, the analysis module 208 sends data representing the question and the matching choices (based on the question ID and the corresponding choice IDs) to the UI module 204, and the UI module 204 sends data representing text and/or images (and/or sounds and/or video where predefined in the choice attributes table 314) for the question and the matching choices (determined in step 518) for the client 202 to display to the user (step 527). The user interface module 204 receives input data representing input of one of the choices from step 527 from the client 202 (step 528). The user interface module 204 is configured to accept input data representing selection of only one choice so the user cannot select more than one answer. The analysis module 208 then adds the choice ID selected in step 528 to the selected choice IDs in the solution profile table (report module) 308 (step 530), and retrieves the applicable environment IDs associated with the selected choice ID in step 528 (step 532). These applicable environment IDs may be referred to as set (E). The analysis module 208 records the question ID associated with step 524 in the traversed question IDs field to indicate that this question has been traversed (step 534). The analysis module 208 determines whether to eliminate any of the selected environment IDs in the solution profile table 308 (set (D)) based on the applicable environments retrieved in step 532 (set (E)) by determining the common environment(s) ID(s) between sets (D) and (E) of the environments (step 536). Set (D) is then updated or replaced with the intersection of previous set (D) and set (E) in the selection profile table 308 (step 538), and the questionnaire process 500 returns to step 504. The intersection of the sets (D) and (E) in the selection profile table 308 is the subset of the selected appropriate platforms.

As shown in Table 1 hereinafter, example questionnaire data may be stored such that each input request is associated with a characteristic ID (identifying a “category”), a question text, choice ID (or choice name), and one or more environment IDs (representing available platforms).

TABLE 1

| Category | Text | ChoiceName | Environment |
|---|---|---|---|
| Managed | What support plan (managed | 24/7 | VSF |
| Services/ | sendees) should be provided for | | |
| Support | the target IT Infrastructure for | | |
| | the workload ? | | |
| Managed | What support plan (managed | 24/7 | EPIC |
| Services/ | services) should be provided for | | |
| Support | the target IT Infrastructure for | | |
| | the workload ? | | |
| Managed | What support plan (managed | 24/7 | AWS |
| Services/ | services) should be provided for | | |
| Support | the target IT Infrastructure for | | |
| | the workload ? | | |
| Managed | What support plan (managed | 24/7 | Microsoft |
| Services/ | services) should be provided for | | Azure |
| Support | the target IT Infrastructure for | | |
| | the workload ? | | |
| Managed | What support plan (managed | 12/5 | EPIC |
| Services/ | services) should be provided for | (during | |
| Support | the target IT Infrastructure for | business | |
| | the workload ? | days only) | |
| Managed | What support plan (managed | 12/5 | VSF |
| Services/ | services) should be provided for | (during | |
| Support | the target IT Infrastructure for | business | |
| | the workload ? | days only) | |
| Managed | What support plan (managed | 12/5 | AWS |
| Services/ | services) should be provided for | (during | |
| Support | the target IT Infrastructure for | business | |
| | the workload ? | days only) | |
| Managed | What support plan (managed | 12/5 | Microsoft |
| Services/ | services) should be provided for | (during | Azure |
| Support | the target IT Infrastructure for | business | |
| | the workload ? | days only) | |
| Managed | What support plan (managed | 12/7 | VSF |
| Services/ | services) should be provided for | (during | |
| Support | the target IT Infrastructure for | local day | |
| | the workload ? | time) | |
| Managed | What support plan (managed | 12/7 | EPIC |
| Services/ | services) should be provided for | (during | |
| Support | the target IT Infrastructure for | local day | |
| | the workload ? | time) | |
| Managed | What support plan (managed | 12/7 | AWS |
| Services/ | services) should be provided for | (during | |
| Support | the target IT Infrastructure for | local day | |
| | the workload ? | time) | |
| Managed | What support plan (managed | 12/7 | Microsoft |
| Services/ | services) should be provided for | (during | Azure |
| Support | the target IT Infrastructure for | local day | |
| | the workload ? | time) | |
| Managed | What support plan (managed | Ad-hoc | Sanbox |
| Services/ | services) should be provided for | | (x86) |
| Support | the target IT Infrastructure for | | |
| | the workload ? | | |
| Managed | What support plan (managed | Ad-hoc | SunSparc |
| Services/ | services) should be provided for | | Sandbox |
| Support | the target IT Infrastructure for | | |
| | the workload ? | | |
| Security | Does the business service | Yes | VSF |
| | process business data which is | | |
| | categorised as a confidential or | | |
| | classified in Telstra? | | |
| Security | Does the business service | Yes | Sunsparc |
| | process business data which is | | Express |
| | categorised as a confidential or | | |
| | classified in Telstra? | | |
| Security | Does the business service | Yes | EPIC |
| | process business data which is | | |
| | categorised as a confidential or | | |
| | classified in Telstra? | | |
| Security | Does the business service | No | VSF |
| | process business data which is | | |
| | categorised as a confidential or | | |
| | classified in Telstra? | | |

In embodiments, the questionnaire process 500 may end when a predetermined, or preselected (by the administrator), number of environment IDs remain in set (D), e.g., 2, 3, 4 or 5.

In embodiments, the steps of the questionnaire process 500 may be executed by the data operations module 209, the analysis module 208 and the UI module 204, as described above. Alternatively, or additionally, the steps may be controlled and/or executed, at least in part, by the questionnaire module 210. Alternatively, the data operations module 209 and the analysis module 208 may be referred to as operating in, with, or within the questionnaire module 210.

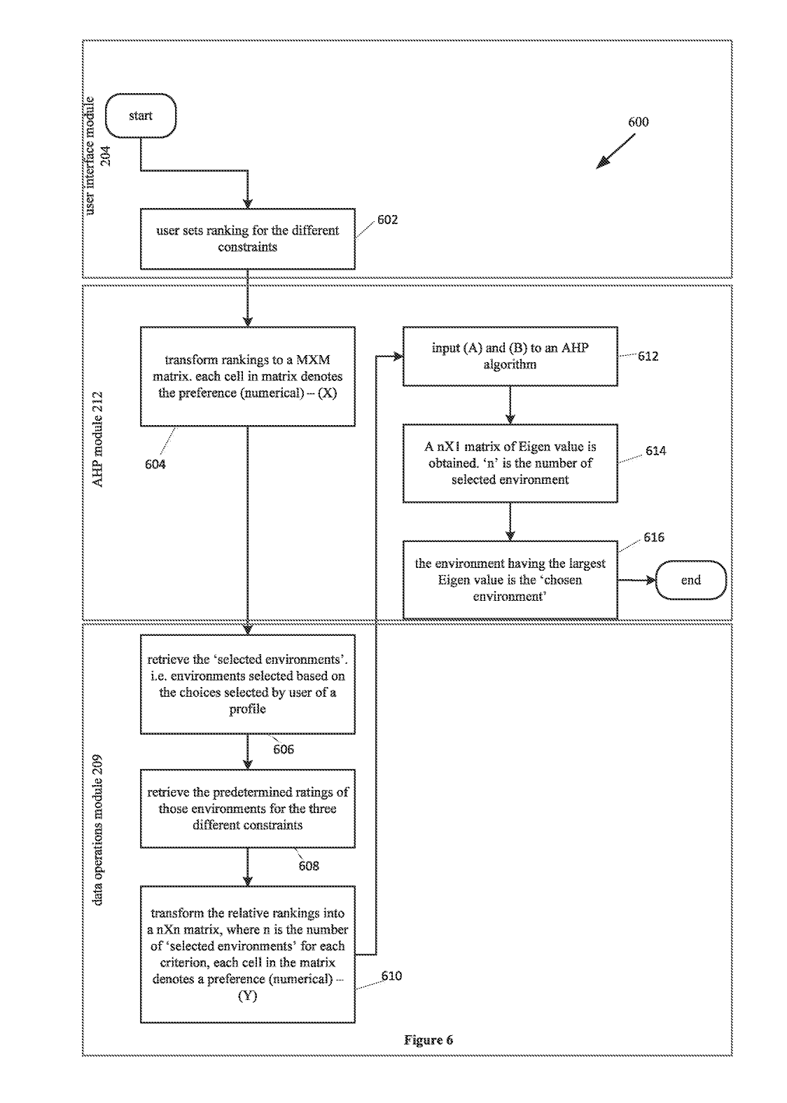

As shown in FIG. 6, the analytic hierarchy process (AHP) 600 commences with the user interface module 204 receiving user input presenting a ranking of pre-selected desirable characteristics (also referred to as “constraints” of a platform (step 602). The values captured represent high, medium and low.

In step 602, the user interface module 204 generates an ordering for the desirable characteristics based on their respective category IDs, and stores them in the user preferences field in the selection profile table 308.

The AHP module 212 receives the ranking from step 602 and generates data representing a square matrix of values, dimensions M by M, where “M” is the number of desirable characteristics in the ranking in step 602 (step 604). The M by M matrix may be referred to as matrix “(X)”. The AHP module 212 generates the values in the matrix based on the ranking (from step 602), and using predetermined values associated with respective ordinal points in the ranking such that the matrix (X) contains numerical pair-wise comparisons of the desirable characteristics (also referred to as “criteria” in AHP terminology). For example, the desirable characteristics, or “criteria”, may include Cost, Security and Uptime; and the predetermined values associated with the rankings may be the integer value of 7 for the first rank, the integer value of 5 for the second rank, and the integer value of 2 for the third rank. The values associated with the rankings may be integer values, and may decrease in value consistently as the rank increases, thus the first rank always has a higher rank value than the second rank, which always has a higher rank value than the third rank ranking, etc. By using integer values for the ranking, this may enable an administrator to accurately and efficiently assign rank values to the rankings when defining these predetermined rankings in the system 100.

In step 604, the AHP module 212 determines the rank value for each ranked characteristic (from step 602) using the predefined rank values, e.g., for a ranking of Security above Cost above Uptime, the respective rank values may be 7 for security, 5 for cost and 2 for uptime. The pair-wise comparison matrix is then determined using numerical comparisons of the values in pairs, in particular using ratios of the rank values such that a ratio of the rank values is generated for each pair of the ranked characteristics. For example, the pair-wise comparison matrix may have values determined as shown in Table 2, where “S” represents the security rank value, “C” represents the cost rank value, and “U” represents the uptime rank value. The AHP module 212 sets high, medium or low for the given constraints to compare them relatively. For example, S may be preferred (high) over C, while C may be preferred (high) over U, and U may be is not preferred over S (not as high as S) and not preferred over C (not high as C).

TABLE 2

| | Security (“S”) | Cost (“C”) | Uptime (“U”) |
|---|---|---|---|
| S | S/S | S/C | S/U |
| C | C/S | C/C | C/U |
| U | U/S | U/C | U/U |

Following generation of the pair-wise comparison matrix (X), the data operations module 209 retrieves the environment IDs of the selected environments in set (D) from the solution profile table 308 (step 606). The data operations module 209 retrieves a predetermined rating for each of the ranked characteristics for each of the selected environments (step 608). These predetermined ratings are applied by the administrator prior to commencement of the AHP 600, and may be selected to be integer values from 1 to 9, where high predetermined ratings are selected if the environment (associated with the environment ID) is understood to have a desirable level or performance of the rated characteristic: thus an environment predetermined to have a low cost may have a high predetermined rating for the cost characteristic. In alternative embodiments, low ratings may be selected for a preferred performance or manifestation of the rated characteristic, and the high value may be selected for an undesirable level of performance, and the values may receive an inverse mathematical treatment in the AHP 600. The predetermined ratings are selected in accordance with the AHP framework using integer values, or equivalent, to allow efficient entry by the administrator and to allow sufficient differentiation of the performance of the different environments, associated with the environment IDs, in respect of the different ranked characteristics. The predetermined ratings may be stored in data storage as set out in Table 3, where predetermined rating values are shown for each combination of environment ID (e.g., #1, #2, #3, etc.) and characteristic ID (e.g., S, C, U, etc.):

TABLE 3

| | Environment #1 | Environment #2 | Environment #3 |
|---|---|---|---|
| S | 9 | 9 | 1 |
| C | 3 | 3 | 3 |
| U | 4 | 5 | 6 |

Once the predetermined ratings for the selected environments in respect of the ranked characteristics are determined in step 608, the data operations module 209 generates an n-by-n pair-wise comparison matrix for each of the ranked characteristics where n is the number of selected environments and each cell in each matrix represents a pair-wise comparison, which may be a ratio, of the predetermined ratings of the characteristics for that environment (step 610). The set of pair-wise comparison matrices based on the predetermined ratings selected and entered by the administrator may be referred to as matrix “(Y)”. In contrast, the matrix (X) is based on the rankings selected and entered by the user in step 602.

The AHP module 212 enters the matrix (X), and the set of matrices (Y) into an AHP algorithm to generate a so-called Eigen value (EV) for each environment (steps 612 and 614). The EV values are generated for each platform considering the S/C/U priority vector values. The AHP algorithm in step 612 may generate a numerical value (priority vector) for each environment using the numerical values of the pair-wise comparison rating matrix (X) and the pair-wise comparison ratings matrices (Y) such that an environment with a high pre-determined rating for a characteristic that has been ranked highly generates a high Eigen value (for the environment), whereas an environment having a low predetermined rating value for a characteristic (S/C/U) with a high ranking value will have a low Eigen value.

In embodiments, in step 612, a so-called “priority vector” may be generated with a priority value for each of the ranked characteristics, and each value in the priority vector may be generated by multiplying the values in each row of (X) together to form a product, and calculating the Mth root of said product. The Mth-root-of-product values may then be normalised to a percentage or fraction using a total of all the Mth-root-of-product values. For the example matrix (X) in Table 2, the first value in the priority vector may be determined using (S/S×S/C×S/U)̂(⅓)/(sum of all the Mth root of product values). The priority vector values are referred to as “criteria weights”, and total to 1.0. Then M priority vectors are generated using an Nth root of products for the environments in each table in (Y). Once the M priority vectors are generated from (Y), the values corresponding to each characteristic or criterion from the priority vectors are extracted to create new environment-dependent vectors, wherein each such vector has a value from the priority vectors corresponding to one of the selected environments and one of the ranked characteristics or criterion. Then a sum-of-products operation is performed on the priority vector from (X) and a vector of equal length having values from the priority vectors of (Y). This sum-of-products is the Eigen value for each environment. Eigen values for an environment are calculated by sum of results of multiplications of the priority vector of each characteristics (S/C/U) by priority vector of respective environment.

In embodiments, similar and/or alternative AHP algorithms may be used, e.g., based on AHP algorithms developed from a publication by Dr. T. L. Saaty entitled “Priority setting in completing problems” published in IEEE Transactions on Engineering Management, volume 30, number 3, August 1983, on pages 140-155, and subsequent publications relating to AHP, e.g., a presentation entitled “The Analytic Hierarchy Process (AHP)”, by Jeff Kunz to the Eagle City Hall Location Options Task Force (February/March 2010) available from: http://www.whitman.edu/mathematics/SeniorProjectArchive/2013/Klutho.pdf.

Following the generation of the AHP Eigen values, the AHP module 212 selects the environment ID corresponding to the largest (greater) of the Eigen values, thus selecting the “chosen environment” (step 616), and saves this to the field AHP Selected Environment ID in the solution profile table 308, and may generate data for display to the user by the user interface 204 (step 616). In embodiments, the AHP module 212 is configured to select a plurality of “chosen environments” using two or more of the largest Eigen values, e.g, the top two or three.

In the AHP 600, the values in the matrices, in the vectors, and the Eigen values etc., are created in computer-readable memory, e.g., RAM, by machine-readable code, e.g., written in Microsoft C#, that implements at least a portion of the AHP 600.

In embodiments, the steps of the AHP 600 may be executed by the data operations module 209 and the AHP module 212, as described above. Alternatively, or additionally, the steps of the data operations module 209 may be controlled and/or executed, at least in part, by the AHP module 212 (i.e., the data operations module 209 may be referred to as operating in, with, or within the AHP module 212).

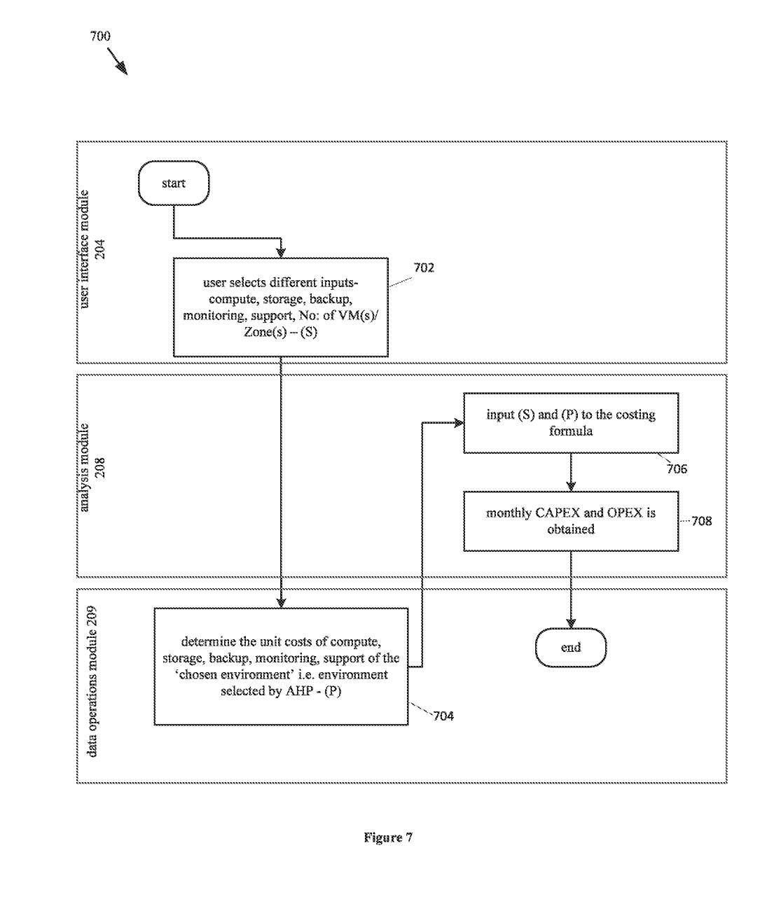

As shown in FIG. 7, the costing process 700 commences with the user interface module 204 receiving inputs from the client 202 representing values for different dimensioning parameters of a platform, which may include computing capacity, storage capacity, backup capacity, the availability of monitoring, support capacity, a number of virtual machines or zones, etc (step 702). The values provided in step 702 may be referred to as set “(S=sizing)”. The data operations module 209 determines cost values, which may be dollar values, for the values provided in step 702, using the chosen suitable environment from the AHP 600, represented as the environment ID, in drawing the unit costs from the unit cost table 332 (step 704). The analysis module 208 performs a costing process, which may include multiplying the unit costs by the requested numbers of units from step 702, and storing the computed costs in the computed costs table 326 (step 706). The analysis module 208 may determine monthly capital expenditure and operational expenditure values from the computed costs in table 322, and store these in the configuration environment mapping table 330 (step 708). In step 708, the analysis module 208 may also report provide monthly and annual costs to host the workload in the identified environment.

The costing process in step 706 may use relationships equivalent to those shown in Table 4 below to process the values from the unit costs table 332. In embodiments, a cost fraction of 30% may be used instead of the “15% of 15% of” values in Table 4 (i.e., a fraction of 0.3 instead of 0.0225). Alternatively, this cost fraction (which can be referred to as a “buffer constant”) can be selected to be between 1% and 100%, or 30% and 50%, for different applications. The cost fraction or buffer constant can be preselected by a developer of the system 100 based on projected cost estimates for the deployment or placement of the system. The Backup value “D” relates to monthly and annual costs to host the workload in the identified environment. If the VMs have different volumes of storage, e.g., based on a tier of the backup (which can be one of up to 5 different tiers), the value “D” is determined by adding total storage per tier and multiplying by the number of specific VMs of that tier. In embodiments the costing can be determined for a workload up to 5 tiers. In a multi-tier environment, the total “D” may thus be determined by summing the values for each tier determined according to the formula in Table 4. In embodiments, the cost values for the Database Constant and the VM Constant are set values (i.e., constant) that are preselected when these set costs change, e.g., once a year, using a user interface of the system 100 for platform owners. This user interface is configured to receive data representing the preselected cost values in Table 4 for storage in the unit costs table 332. In embodiments, the Mandatory Services (G) and the IP Address (M) elements can be replaced with a Database Constant (Instantiation) (G) element and a VM Constant (VM Instantiation) (M) element respectively, as shown in Table 4.

TABLE 4

| Parameter | Formula |
|---|---|
| CPU (A) | 15% of 15% of (#vCPU * Unit Cost |
| | Per vCPU * #VM) |
| RAM (B) | 15% of 15% of (#GB RAM * Unit |
| | Cost Per RAM * #VM) |
| Storage (C) | 15% of 15% of (#GB * Unit Cost of |
| | storage Per GB * #VM) |
| Backup (D) | 15% of 15% of (#GB * Unit Cost of |
| | backup per GB * #VM) |
| Monitoring (E) | 15% of 15% of (Unit cost of |
| | monitoring * #VM) |
| Managed Services (F) | 15% of 15% of (Unit cost of |
| | managed services * #VM) |
| Mandatory Services (G) | 15% of 15% of (Unit cost of |
| or | mandatory Services) |
| Database Constant (G) | or |
| | a constant preselected cost value |
| | representing costs of installation, a |
| | software license and labour (e.g., |
| | $2000 for a certain SGL Database) |
| OS License (H) | 15% of 15% of (Unit cost per |
| | license * #VM) |
| Compute (e.g., for Sun Sparc | 15% of 15% of (Unit cost per |
| Express) (I) | compute * #Zone) |
| Load Balancer (J) | 15% of 15% of (Unit cost of load |
| | balancer) |
| Firewall (K) | 15% of 15% of (Unit cost of firewall) |
| Network (L) | 15% of 15% of (Unit cost of network |
| | bandwidth utilisation) |
| IP Address (M) | 15% of 15% of (Unit Cost of IP |
| or | Address) |
| VM Constant (M) | or |
| | a constant preselected cost value |
| | representing costs of installation, |
| | labour and a software licence. |
| Monthly cost (N) | A + B + C + D + E + F + G + H + I + |
| | J + K + L + M + N |
| Yearly Cost (O) | (N) * 12 |

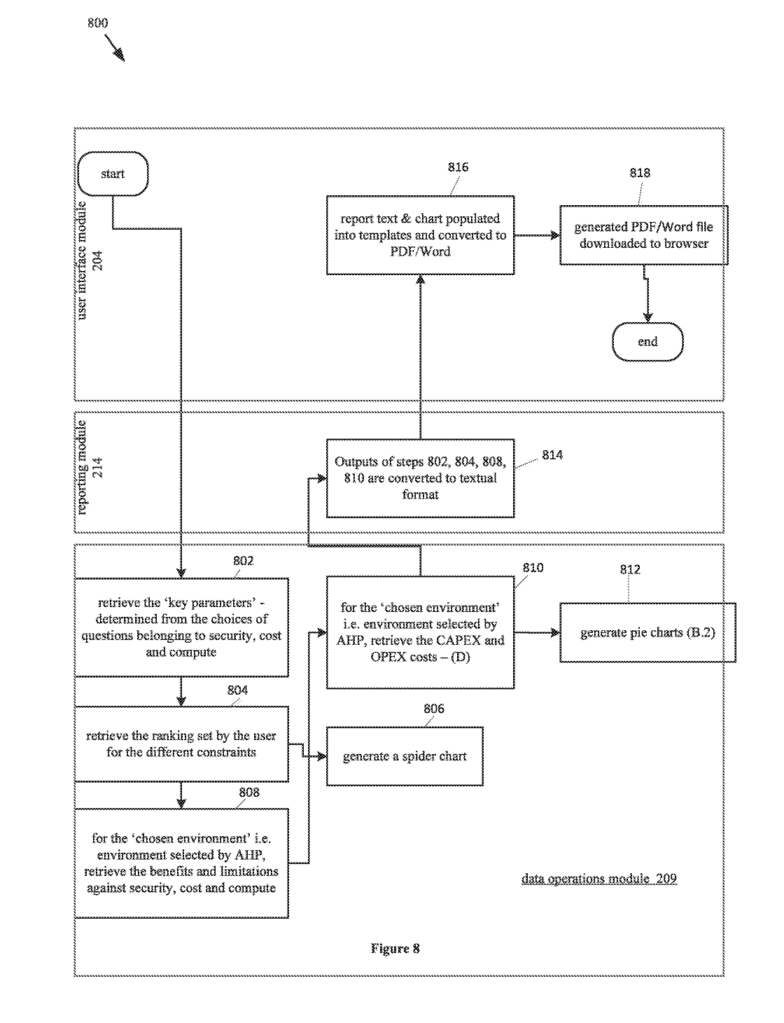

As shown in FIG. 8, in the report generation process 800, the data operations module 209 retrieves “key parameters” from the selected choice IDs in the solution profile table 308. The questions are categorised under key parameters viz Security, Cost, Uptime etc. (step 802). The selected rankings from step 602 are retrieved by the data operations module 209 from the database 110 (step 804), and the data operations module 209 generates a spider chart showing the ranking values associated with the selected rankings (step 806). The data operations module 209 retrieves the predetermined data representing benefits and shortcomings (limitations) for the chosen environment (or plurality of chosen environments) from the AHP 600 (identified using the chosen environment ID or IDs) from the environment categories mapping table 306 (step 808). The data operations module 209 retrieves the CapEx and OpEx values for the chosen environment ID or IDs from the AHP 600 from the configuration environment mapping table 330 (step 810). The data operations module 209 generates pie charts showing the CapEx and OpEx for display by the user interface module 204 (step 812). The reporting module 214 converts the data outputs of steps 802, 804, 808, and 810 into textual format (step 814), and the user interface module 204 displays the textual data from step 814 as a user interface screen, and as a portable document format (PDF) file, or Microsoft Word file or equivalent, for export (step 816). The user interface module 204 also generates the PDF file, Word file or equivalent, for download to the client 202 (step 818). In embodiments, the entire report format is modular, all the sections of the reports can be enabled, disabled by an administrator tool, and these settings apply to future reports.

### Interpretation

Many modifications will be apparent to those skilled in the art without departing from the scope of the present invention.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A cloud platform selection system including:
a questionnaire module configured to:
select input requests from a plurality of predetermined input requests relating to a plurality of preselected cloud computing platforms,
send data to a user-interface (UI) module representing each input request and a plurality of choices for selection in response to each input request,
receive user input data representing selection of one of the plurality of choices for each input request, and
determine a subset of platforms from the preselected cloud computing platforms using the user input data and predefined associations between the choices and the preselected cloud computing platforms; and
an analytical hierarchy process module configured to:
receive user input data representing a ranking of characteristics of the preselected cloud computing platforms,
access predefined ratings of the characteristics for the determined subset of platforms, and
determine a suitable platform of the subset using the ranking and the predefined ratings in an analytical hierarchy process.

2. The system of claim 1, including a reporting module for generating a report based on the characteristics of the determined suitable platform.

3. The system of claim 1, including the UI module configured to:
receive user input to generate the user input data, and
generate data to display the determined suitable platform.

4. The system of claim 1, wherein the questionnaire module is configured to select at least one input request based on user input data received in response to a previous one of the selected input requests.

5. The system of claim 1, wherein the predetermined input requests include multiple-choice questions, single-choice questions, and value requests.

6. The system of claim 1, wherein each choice is represented by a choice identifier (ID).

7. The system of claim 6, wherein each predetermined platform is represented by a platform ID.

8. The system of claim 7, wherein the predefined associations between the choices and the preselected cloud computing platforms are represented as mappings between the choice IDs and the platform IDs.

9. The system of claim 1, wherein the predetermined input requests are in at least one electronic database.

10. The system of claim 1, wherein the questionnaire module is configured to generate the input requests until the predefined user input requests that are associated with remaining platforms in the subset have received input.

11. The system of claim 1, wherein the questionnaire module generates the user input requests until a preselected number of the platforms remains in the subset.

12. The system of claim 1, wherein the user input representing the ranking includes ranking data indicative of relative importance values of the characteristics.

13. The system of claim 1, wherein a plurality of suitable platforms are determined in the analytical hierarchy process.

14. A cloud platform selection method including the steps of:
selecting input requests from a plurality of predetermined input requests relating to a plurality of preselected cloud computing platforms;
sending data to a user-interface (UI) module representing each input request and a plurality of choices for selection in response to each input request;
receiving user input data representing selection of one of the plurality of choices for each input request;
determining a subset of platforms from the preselected cloud computing platforms using the user input data and predefined associations between the choices and the preselected cloud computing platforms;
receiving user input data representing a ranking of characteristics of the preselected cloud computing platforms;
accessing predefined ratings of the characteristics for the determined subset of platforms; and
determining a suitable platform of the subset using the ranking and the predefined ratings in an analytical hierarchy process.

15. The method of claim 14, including selecting at least one input request based on user input data received in response to a previous one of the selected input requests.

16. The method of claim 14, wherein the predetermined input requests include multiple-choice questions, single-choice questions, and value requests.

17. The method of claim 14, including generating the input requests until the predefined user input requests that are associated with remaining platforms in the subset have received input.

18. The method of claim 14, including generating the user input requests until a preselected number of the platforms remains in the subset.

19. The method of claim 14, wherein the user input representing the ranking includes ranking data indicative of relative importance values of the characteristics.

20. One or more non-transitory computer-readable storage media including machine-readable code that causes one or more computer processors to execute the method of claim 14.
